(19) United States
(12) Patent Application Publication
(10) Pub. No.: US 2011/0026209 A1
(43) Pub. Date: Feb. 3, 2011

(54) KEYBOARD CADDY

(75) Inventor: Thomas BORSE, Woodridge, IL (US)

Correspondence Address: Momkus McCluskey, LLC, 1001 Warrenville Road, Suite 500, Lisle, IL, 60532, US

(73) Assignee: ANGLE TOOL WORKS INC., Burr Ridge, IL (US)

(21) Appl. No.: 12/901,879

(22) Filed: Oct. 11, 2010

Related U.S. Application Data
(63) Continuation-in-part of application No. 12/422,400, filed on Apr. 13, 2009.

(51) Int. Cl. G06F 1/16; A47F 7/00

(52) U.S. Cl. 361/679.08; 211/26

(57) ABSTRACT

A desktop organizer for association with a keyboard having legs comprises a body having one or more compartments and two keyboard attachment sections that are integrally formed with the body. Each keyboard attachment section includes a plurality of recesses or slots that are each adapted to receive a foot of a keyboard.

### RELATED APPLICATIONS

This application is a continuation in part of U.S. patent application Ser. No. 12/422,400, filed Apr. 13, 2009, the specification and drawings of which are fully incorporated by reference herein.

### BACKGROUND OF THE INVENTION

Increasingly, many tasks are done at a keyboard and in front of a display. Desktop organizers are used to keep office workspaces clear and orderly by storing the commonly used items such as paperclips, pens, pencils, rubber bands, erasers, and the like. Organizing such office supplies increases worker productivity by decreasing the amount of time lost looking for particular items. Additionally, organized work environments reduce worker frustration and enhance a sense of control over the amount of work to be accomplished.

A wide variety of desktop organizers are available but are frequently out of reach because they are not proximate to or secured to the keyboard. Prior art organizers that attach to the keyboard are inadequate because they use adhesives to attach the organizer to the keyboard, which makes adjustments or removal of the organizer difficult. Additionally, this often leaves the keyboard sticky with adhesive that was not completely removed.

Additionally, coffee cups or other beverage containers are frequently present on the desktop and are at risk of being spilled by the worker when he or she reaches for other items. Therefore, there exists a need for a desktop organizer that is secured to the keyboard without the use of adhesives so that the items are always in a fixed position relative to the keyboard.

### SUMMARY OF THE INVENTION

According to one aspect of the invention, an organizer for association with a computer keyboard comprises a body having a right end, a left end spaced from the right end, and at least one compartment between the right end and the left end for receiving office supplies and the like. Additionally, the organizer comprises a right keyboard attachment section integrally formed with the right end of the body and a left keyboard attachment section integrally formed with the left end of the body and being spaced from the right keyboard attachment section by a central rear margin. Each keyboard attachment section includes a plurality of recesses, with each recess being separated from the others by an upstanding wall. The recesses are each adapted to receive a foot of a keyboard.

Preferably, the recesses have a top opening and a bottom, with an area of the top opening being greater than the area at the bottom such that the feet of a keyboard register to a predetermined widthwise position when placed in the recesses.

In addition, the organizer may include compartments for other items commonly found in a workspace. For example, the organizer may include one or more cup holders to prevent spillage in the event the user accidentally jars the cup. The cup holder itself may be sized to fit two or more sizes of cups, having a first receiving surface that is lower than, smaller than, and substantially surrounded by the second receiving surface. Preferably, the first receiving surface is coplanar with the bottom of a second storage compartment.

In another aspect of the invention, an organizer comprises a body having a right end, a left end spaced from the right end in a lengthwise direction, a forward margin that extends in a lengthwise direction from the right end to the left end of the body, and a central rear margin that is spaced rearwardly from the forward margin and extends in a lengthwise direction. The central rear margin has a left end that is rightwardly spaced from the left end of the body and a right end which is leftwardly spaced from the right end of the body. The organizer has at least one compartment between the right end, the left end, the forward margin, and the central rear margin of the body.

A left keyboard attachment section is disposed to be between the left end of the body and the left end of the central rear margin and extends rearwardly from the central rear margin of the body. A right keyboard attachment section is disposed to be between the right end of the body and the right end of the central rear margin and extends rearwardly from the central rear margin of the body. The right keyboard attachment section is spaced from the left keyboard attachment section by the central rear margin.

Each keyboard attachment section is adapted to receive a foot of the keyboard and includes one or both of (1) a lengthwise elongate slot through the organizer and (2) a plurality of lengthwise elongate recesses. Each recess is separated from the others by an upstanding wall.

A system comprises a computer keyboard having a right foot, a left foot, and an organizer. The organizer includes a body having a right end, a left end that is spaced from the right end in a lengthwise direction, a forward margin that extends lengthwise from the right end to the left end of the body, and a central rear margin that is spaced rearwardly from the forward margin and extends in a lengthwise direction. The central rear margin has a left end that is rightwardly spaced from the left end of the body and a right end which is leftwardly spaced from the right end of the body. The organizer has a compartment between the right end, the left end, the forward margin, and the central rear margin.

A left keyboard attachment section is disposed between the left end of the body and the left end of the central rear margin and extends rearwardly from the central rear margin of the body. A right keyboard attachment section is disposed between the right end of the body and the right end of the central rear margin and extends rearwardly from the central rear margin of the body. The right keyboard attachment section is spaced from the left keyboard attachment section by the central rear margin. Each keyboard attachment section includes one or both of a lengthwise elongate slot through the organizer or a recess adapted to receive a foot of the keyboard.

A system comprises a wireless computer keyboard having a right foot, a left foot, and an organizer. The organizer has a body with a right end, a left end that is spaced from the right end in a lengthwise direction, and a forward margin that extends lengthwise from the right end to the left end. A rear margin is spaced rearwardly from the forward margin and extends in a lengthwise direction and the organizer has at least one compartment between the right end, the left end, and the forward and rear margins. A composite keyboard attachment section is disposed from the left end of the body to the right end of the body and extends rearwardly from the rear margin of the body.

### BRIEF DESCRIPTION OF THE DRAWINGS

Further aspects of the invention and their advantages can be discerned in the following detailed description, in which like characters denote like parts and in which:

FIG. 1 is an isometric view of a first embodiment of the invention;

FIG. 2 is a side view taken substantially along line 2-2 of FIG. 1;

FIG. 3 is a side view taken substantially along line 3-3 of FIG. 1;

FIG. 4 is a side view of the embodiment shown in FIGS. 1-3, as it is being attached to a keyboard;

FIG. 5 is a top view of the embodiment shown in FIGS. 1-3, after it is attached to the keyboard;

FIG. 6 is a side view taken substantially along line 6-6 of FIG. 5, showing a portion of the right end broken away and a leg of the keyboard resting on an inside surface of the organizer;

FIG. 7 is a top view of a second embodiment of the invention, where two of the storage compartments are cupholders;

FIG. 8 is a top view of a third embodiment showing slots in the keyboard attachment sections;

FIG. 9A is a side view of the right end of the organizer taken substantially along line 9A-9A of FIG. 8;

FIG. 9B is a sectional detail of the right end of the organizer and a keyboard mounted on it; and

FIG. 10 is a top view of a wireless keyboard organizer having a composite keyboard attachment section and showing a slot and two recesses extending from the left end of the organizer to the right end of the organizer.

### DETAILED DESCRIPTION

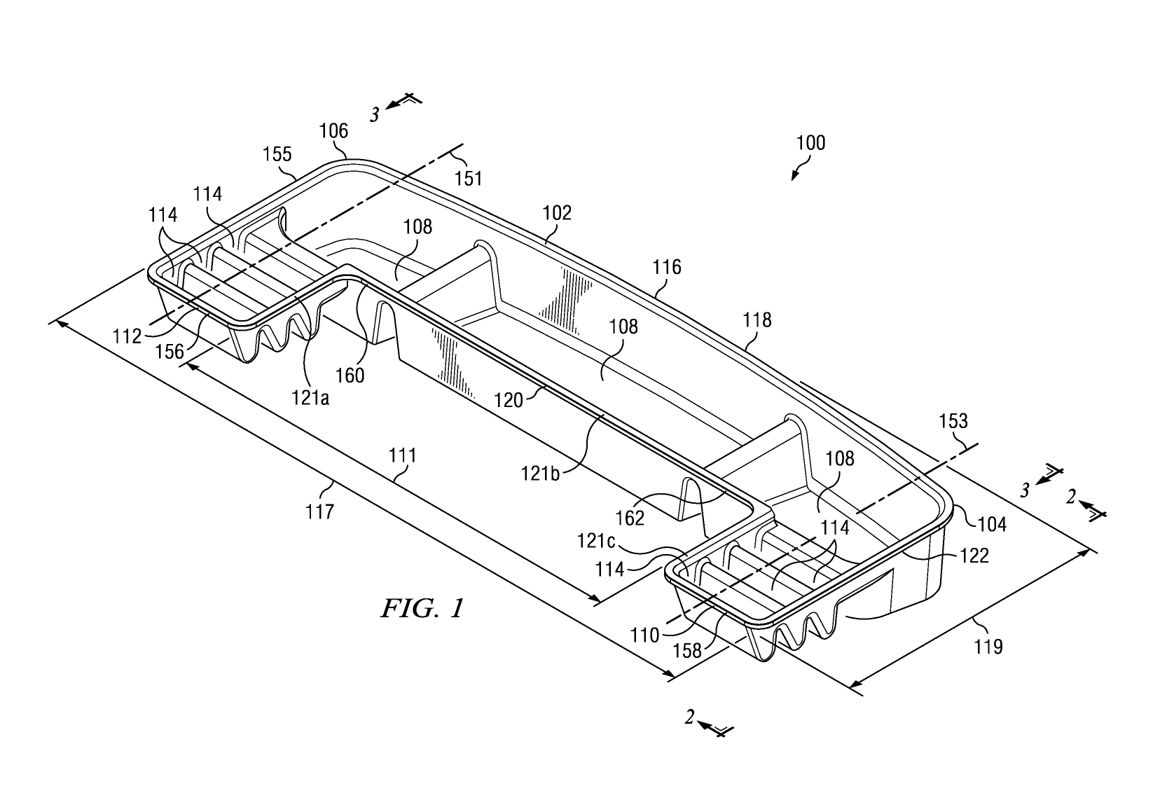

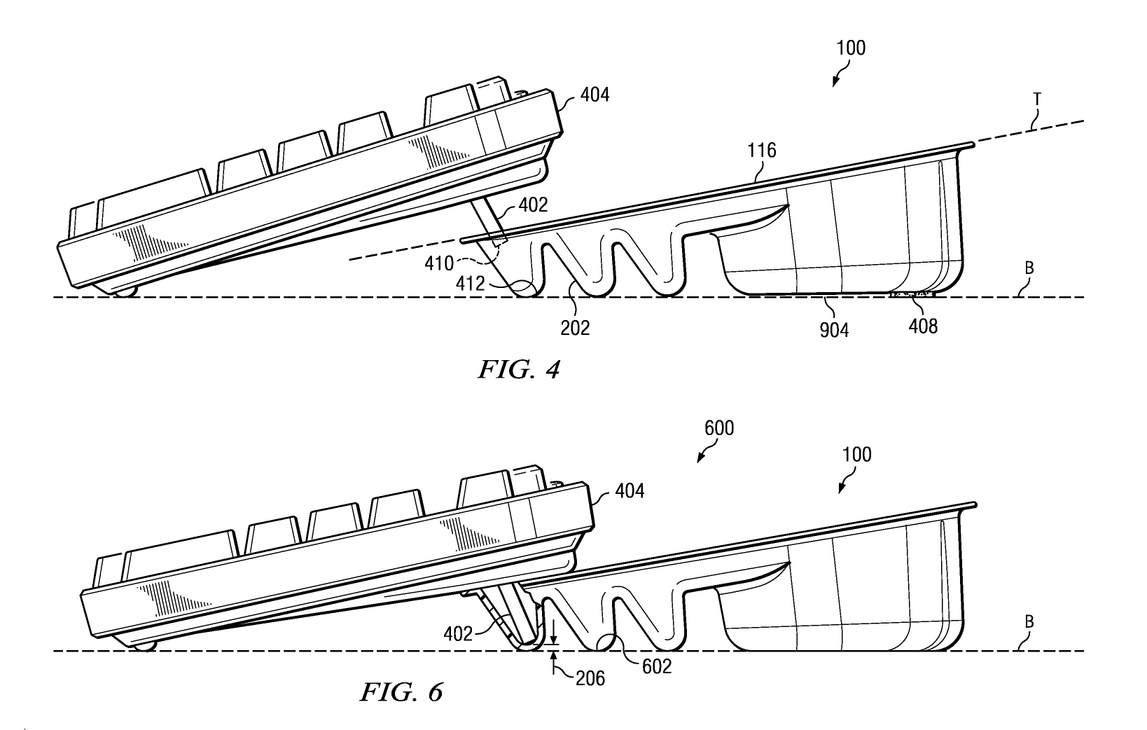

Referring to FIGS. 1 and 4, an organizer, indicated generally at 100, comprises a body 102 having a right end 104 and a left end 106 spaced from the right end 104 in a lengthwise direction. The organizer has a forward margin 118 extending lengthwise from the right end 104 to the left end 106 and a central rear margin 120 spaced rearward from the forward margin 118. The central rear margin 120 extends generally in a lengthwise direction and has a left end 160 that is rightwardly spaced from the left end 106 of the body 102 and a right end 162 which is leftwardly spaced from the right end 104 of the body 102. The central rear margin 120 preferably comprises a left section 121a, a center section 121b, and a right section 121c.

The organizer 100 has one or more compartments 108 between the right end 104, the left end 106, the forward margin 118, and the central rear margin 120 for receiving office supplies and the like.

The organizer 100 further comprises a left keyboard attachment section 112 between the left end 106 of the body 102 and the left end 160 of the central rear margin 120. The left keyboard attachment section 112 extends rearwardly from the central rear margin 120 of the body 102, preferably by approximately 0.5 to 5 inches.

A right keyboard attachment 110 section is disposed between the right end 104 of the body and the right end 162 of the central rear margin 120. The right keyboard attachment section 110 extends rearwardly from the central rear margin 120 of the body 102 and is spaced from the left keyboard attachment section 112 by the center section 121b. The center section 121b of the central rear margin 120 may have a length of between approximately 1 inch to 15 inches but is preferably between approximately 9 and 11 inches.

Thus, the right and left keyboard attachment sections 110, 112 preferably are longitudinally spaced apart by a rearward length 111 which is chosen to be less than a length of most standard computer keyboards. Lateral centers 151 and 153 of the respective attachment sections 110, 112 are chosen to be spaced apart by a length that approximates the spacing of the legs of a conventional keyboard. Attachment section rear margins 156, 158 of the left and right keyboard attachment sections 112, 110 are approximately 0.5 to 5 inches rearward of the center section 121b of the central rear margin 120. More preferably, the keyboard attachment sections 110, 112 are integrally formed with the body 102.

Each keyboard attachment section 110, 112 includes a plurality of lengthwise elongate recesses 114 with each recess 114 being separated from the others by an upstanding wall 202 and is adapted to receive a foot 402 of a keyboard 404 (see FIGS. 4 and 6).

Each recess 114 has a top opening 204 and a bottom 206. An area 208 of the top opening 204 is greater than the area 210 at the bottom 206 of the recess 114 such that the feet 402 of the keyboard 404 register to predetermined positions in relation to the central rear margin 120 when placed in any of the recesses 114. Preferably, the top opening 204 has a width of about 0.05 inches to about 0.5 inches and the left and right keyboard attachment sections 112, 110 are each approximately 0.5 to 6 inches long in a lengthwise direction in order to be wide enough to support a range of keyboard leg 402 spacings.

In addition to or instead of a recess 114, each keyboard attachment section 110, 112 may have one or more slots 802 (see FIG. 8) that extends through the organizer 100. Preferably, the slot 802 is an elongate slot that extends in a lengthwise direction. Additional slots 802 may be placed forward of the first slot, making the position of the organizer 100 adjustable in relation to the keyboard 404.

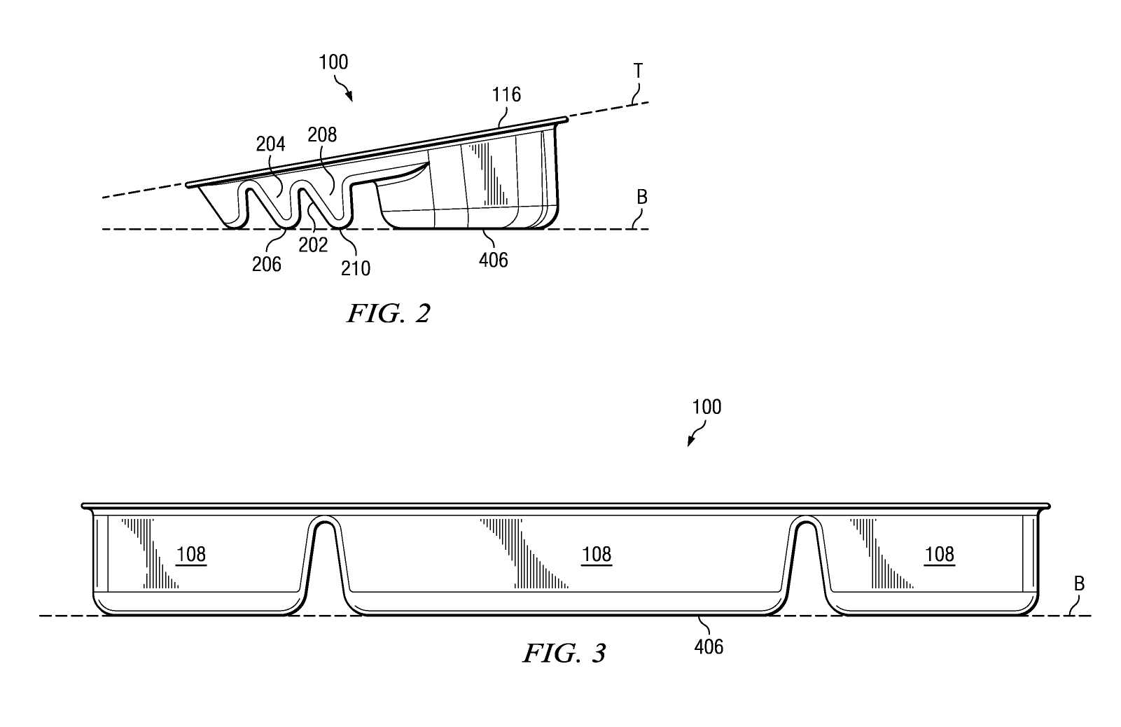

The organizer 100 has a length 117 and a width 119 that may be larger or smaller than the length of the keyboard and may further include a circumferential lip 116 around a perimeter of the body 102, the right keyboard attachment section 110, and the left keyboard section 112. The circumferential lip 116 comprises the forward margin 118, the central rear margin 120, right and left lateral exterior margins 122, 155 oriented in a width direction, and attachment section rear margins 156, 158. Preferably, upper surfaces of the forward margin 118, the lateral exterior margins 122, 155, the attachment section rear margins 156, 158, and the central rear margin 120 substantially conform to a top plane T that is inclined from the forward margin 118 rearwardly and downwardly to the central rear margin 120 as depicted in FIG. 2. Preferably, the plane T can be inclined from approximately zero degrees to approximately thirty degrees. Most preferably, the plane T is inclined by eight degrees.

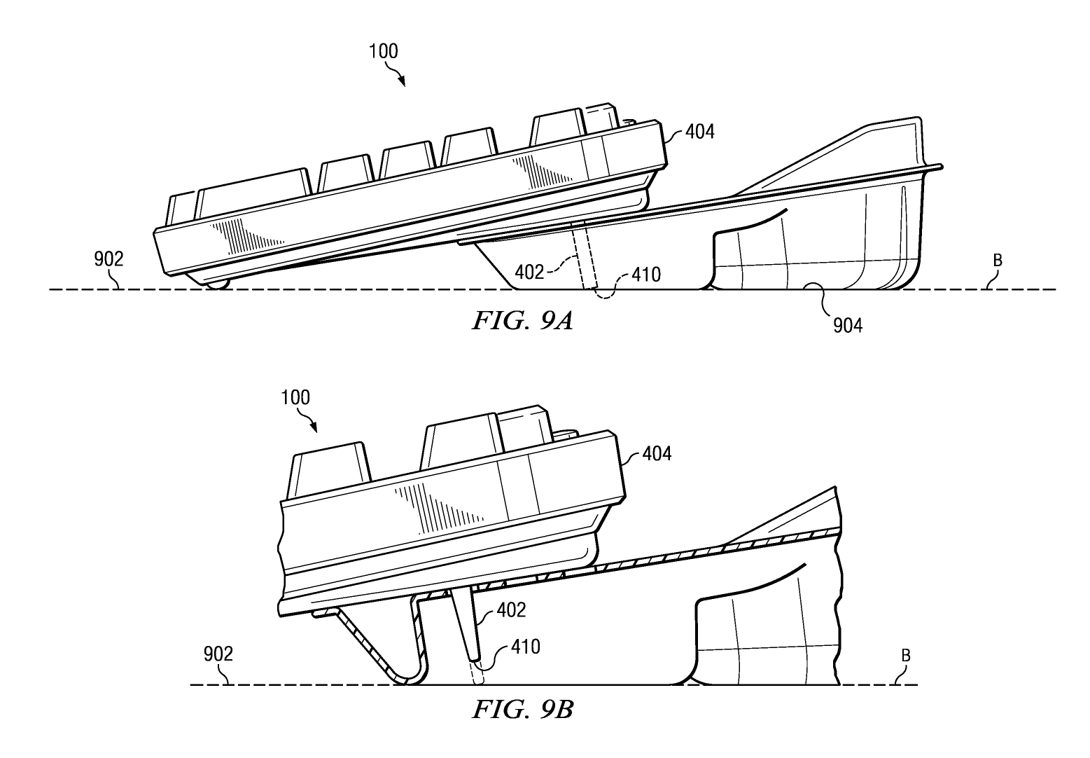

A bottom surface 904 (see FIG. 9) of the organizer 100 is preferably formed to be coplanar with a bottom plane B (see FIGS. 2 and 3). Thus, depending on the length of the left and right feet 402 of the keyboard 404, a bottom surface 904 of the keyboard 404 may either rest on the circumferential lip 116 or be raised slightly above the circumferential lip 116.

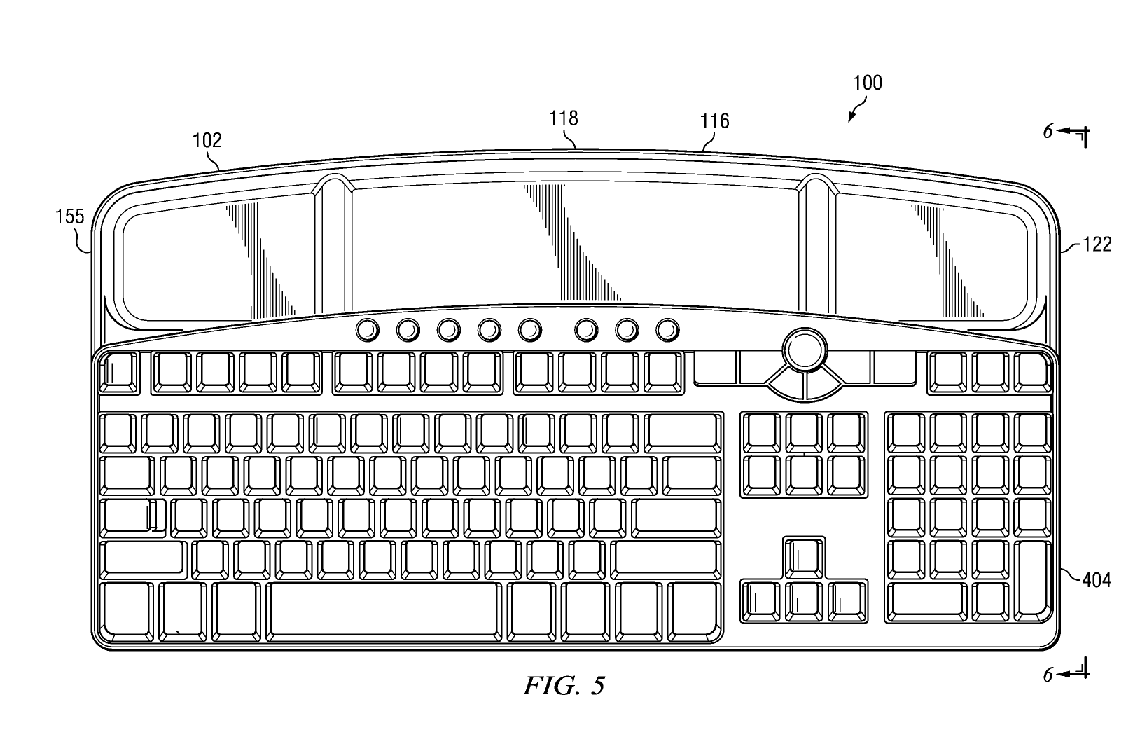

The upstanding walls 202 that separate the recesses 114 may be lower than the circumferential lip 116 so that the upstanding wall 202 does not support the keyboard 212. FIG. 5 shows the organizer 100 being used in conjunction with a keyboard 404.

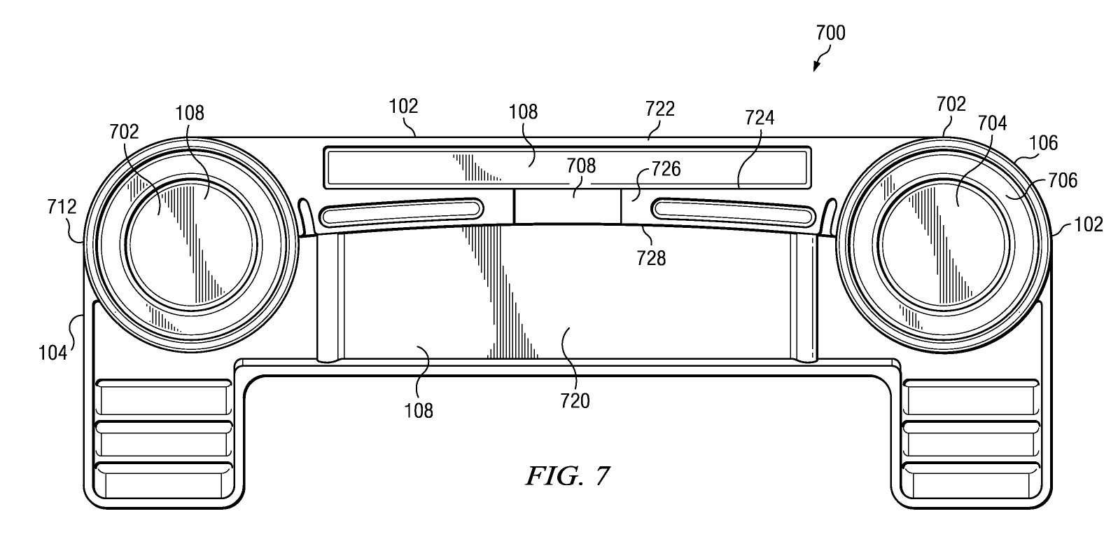

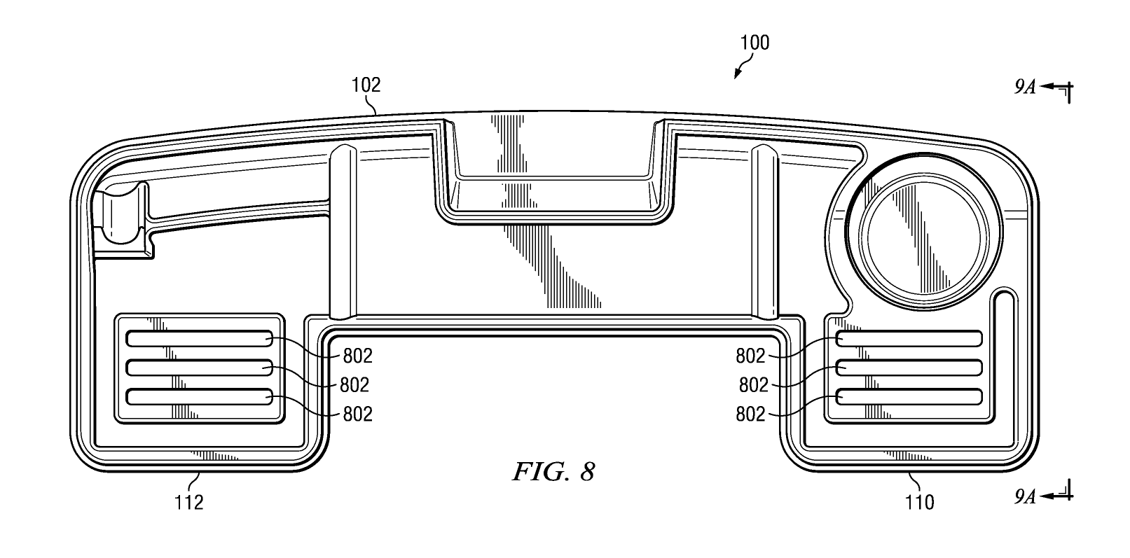

Referring to FIGS. 1 and 7, the organizer 100 may have a plurality of storage compartments 108. In the embodiment shown in FIG. 7, two of the compartments 108 are cupholders 702. The cupholder 702 may have at least a first receiving surface 704 and a second receiving surface 706, the first receiving surface 704 being lower than, smaller than, substantially surrounded by the second receiving surface 706, and coplanar with the bottom plane B.

Specifically with regard to FIG. 7, the organizer 700 may also have a stiffening member 708 between the right end 104 and left end 106 that acts to stiffen the body 102 against flexion out of the horizontal plane (not shown). The stiffening member 708 is formed as an inverted “U”. A forward upstanding sidewall 724 extends upwardly from the bottom of a forward storage compartment 722 and terminates in a horizontal plate 726. Plate 726 extends horizontally and rearwardly and is terminated by a rearward upstanding sidewall 728, which in turn extends from plate 726 to the bottom of rearward compartment 720. As so constructed, member 708 will resist bending or flexion forces acting orthogonally to the plane of the paper, as might be imposed on organizer 700 by putting a drink-filled cup into one of the cupholders 702.

Referring back to FIG. 4, the bottom surface 904 may have one or more friction devices 408 that reside in the bottom plane B and engage the surface upon which the organizer sits to prevent movement. These friction devices 408 may be made of felt, rubber, adhesive tape, putty, adhesive foam, or plastic.

The organizer 100 may be made through a variety of techniques such as injection molding or thermoforming. If thermoforming is used, the body 102, first keyboard attachment section 110, and second keyboard attachment section 112 are preferably formed from a single sheet of material having a substantially uniform thickness.

Referring to FIGS. 1, 4, and 6, a system 600 according to the invention comprises a computer keyboard 404 having right and left feet 402 and an organizer 100 having a body 102 with a right end 104 and a left end 106 spaced from the right end 104 in a lengthwise direction. The organizer has a forward margin 118 extending lengthwise from the right end 106 to the left end 104 of the body 102 and a central rear margin 120 spaced rearwardly from the forward margin 118. The central rear margin 120 extends generally in a lengthwise direction and the central rear margin 120 has a left end 160 that is rightwardly disposed from the left end 104 of the body 102 and a right end 162 that is leftwardly spaced from the right end of the body. The organizer 100 has one or more compartments 108 between the right end 104, the left end 106, the forward margin 118, and the central rear margin 120 for receiving office supplies and the like.

The organizer 100 further comprises a left keyboard attachment section 112 between the left end 106 of the body 102 and a left end 160 of the central rear margin 120. The left keyboard attachment section 112 extends rearwardly from the central rear margin 120 of the body 102, preferably by approximately 0.5 to 5 inches.

A right keyboard attachment 110 section is disposed between the right end 104 of the body and a right end 162 of the central rear margin 120. The right keyboard attachment section 110 extends rearwardly from the central rear margin 120 and is spaced from the left keyboard attachment section 112 by a center portion 121 of the central rear margin 120. Each keyboard attachment section includes a first lengthwise elongate slot, a recess, or both, which is adapted to receive a foot of the keyboard. Each keyboard attachment section may have five or more elongate slots. Each slot may have a width of between approximately 0.05 inches to approximately 0.5 inches and a length of between approximately 0.5 inches to approximately 10 inches.

In a preferred embodiment shown in FIGS. 9A and 9B, each foot 402 has an end or support surface 410 that is inserted through the respective first elongate slots 802 (FIG. 8) of each keyboard attachment section 110, 112 to be coplanar with the bottom plane B. As above, each keyboard attachment section 110, 112 may have a second lengthwise elongate slot 802 disposed to be forward of the first elongate slot 802, making the position of the organizer 100 adjustable in relation to the keyboard 404.

Referring back to FIGS. 2 and 6, each keyboard attachment section 110, 112 may have a plurality of lengthwise elongate recesses 114 in addition to or in place of the slots 802. Each recess 114 has a recess bottom 206 where the depth and position of each recess bottom 206 is preselected such that only a thickness 602 (see FIG. 6) of the recess bottom 206 spaces the support surface 410 of each foot 402 from the bottom plane B. Preferably, the recesses 114 are separated from each other by an upstanding wall 202 that is adapted to receive a foot 402 of the keyboard 404.

More preferably, the angle of the keyboard, produced by extending the feet, substantially matches the angle between the top plane T and the bottom plane B and ranges from approximately five degrees to about thirty degrees.

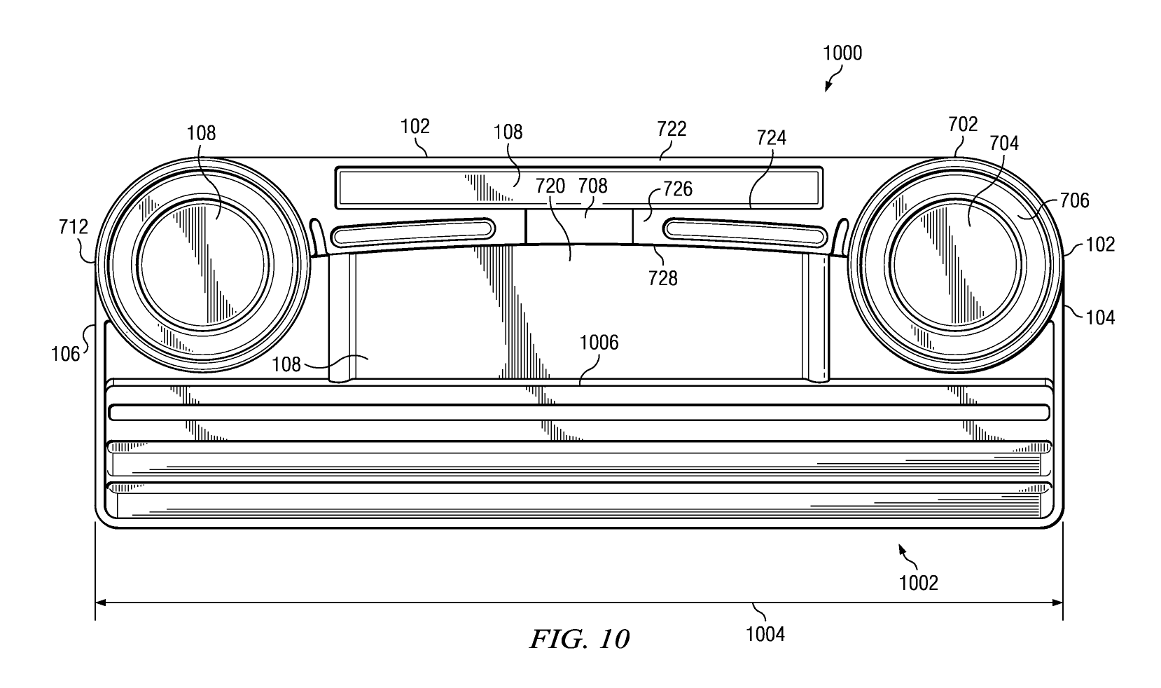

Referring to FIG. 10, a system comprises a wireless keyboard (not shown) and an organizer, indicated generally at 1000, including a body 102 and compartments 108 as described above. The keyboard attachment sections 110, 112 shown in FIG. 1 can be integrated into a composite keyboard attachment section 1002 that reaches from the left end 106 of the body 102 to the right end 104 of the body 102 and extends rearwardly from a rear margin 1006 of the body 102.

In summary, the organizer provides a cost effective way of securing an organizer to a keyboard so that the user may reduce clutter in the work area and increase worker efficiency.

While illustrated embodiments of the present invention have been described and illustrated in the appended drawings, the present invention is not limited thereto but only by the scope and spirit of the appended claims.

I claim:

1. An organizer for association with a computer keyboard, comprising:
a body having a right end, a left end spaced from the right end in a lengthwise direction, a forward margin extending lengthwise from the right end to the left end of the body, and a central rear margin spaced rearward from the forward margin and extending in a lengthwise direction, the central rear margin having a left end rightwardly spaced from the left end of the body and a right end which is leftwardly spaced from the right end of the body;
at least one compartment disposed between the right end, left end, forward margin, and central rear margin of the body;
a left keyboard attachment section disposed between the left end of the body and the left end of the central rear margin, the left keyboard attachment section extending rearwardly from the central rear margin of the body; and
a right keyboard attachment section disposed between the right end of the body and the right end of the central rear margin, the right keyboard attachment section extending rearwardly from the central rear margin of the body and being spaced from the left keyboard attachment section by the central rear margin;
wherein each keyboard attachment section includes a plurality of lengthwise elongate recesses, each recess being separated from the others by an upstanding wall and being adapted to receive a foot of the keyboard.

2. The organizer of claim 1, wherein the central rear margin comprises a center section having a length in the range of about nine inches to about eleven inches long.

3. The organizer of claim 1, wherein each recess has a top opening and a bottom, an area of the top opening being greater than an area of the bottom of the recess such that feet of a keyboard register to a predetermined position in relation to the central rear margin when placed in any of the recesses.

4. The organizer of claim 3, wherein an attachment section rear margin of each of the left and right keyboard attachment sections is rearward of the central rear margin by a distance in the range of about one half inch to about five inches.

5. The organizer of claim 1, wherein the left and right keyboard attachment sections have a length in the range of about one half inch to six inches long.

6. The organizer of claim 1, further comprising a left lateral exterior margin, a right lateral exterior margin;
wherein the forward margin, the central rear margin, the left lateral exterior margin, and the right lateral exterior margin are in a plane inclined from the forward margin rearwardly and downwardly to the central rear margin.

7. The organizer of claim 1, wherein the body is formed from a single sheet of material.

8. The organizer of claim 1, further comprising a bottom surface and a bottom plane, wherein multiple spaced-apart points of the bottom surface are coplanar with the bottom plane.

9. The organizer of claim 8, wherein the at least one compartment is a cupholder.

10. The organizer of claim 9, wherein the cupholder has at least a first receiving surface and a second receiving surface, the first receiving surface being lower than the second receiving surface and coplanar with the bottom plane.

11. The organizer of claim 8, the bottom surface further comprising a friction device.

12. The organizer of claim 11, wherein the friction device is selected from the group consisting of felt, rubber, adhesive tape, putty, adhesive foam, or plastic.

13. The organizer of claim 1, wherein the body further comprises a stiffening member between the right end and the left end of the body that acts to stiffen the body against flexion out of a horizontal plane.

14. An organizer for association with a computer keyboard, comprising:
a body having a right end, a left end spaced from the right end in a lengthwise direction, a forward margin extending lengthwise from the right end to the left end of the body, and a central rear margin spaced rearward from the forward margin and extending in a lengthwise direction, the central rear margin having a left end rightwardly spaced from the left end of the body and a right end which is leftwardly spaced from the right end of the body;
at least one compartment disposed between the right end, left end, forward margin, and central rear margin of the body;
a left keyboard attachment section disposed between the left end of the body and the left end of the central rear margin, the left keyboard attachment section extending rearwardly from the central rear margin of the body; and
a right keyboard attachment section disposed between the right end of the body and the right end of the central rear margin, the right keyboard attachment section extending rearwardly from the central rear margin of the body and being spaced from the left keyboard attachment section by the central rear margin;
wherein each keyboard attachment section includes a first lengthwise elongate slot through the organizer.

15. The organizer of claim 14, each keyboard attachment section further comprising a second lengthwise elongate slot disposed to be forward of the first elongate slot, making the position of the organizer adjustable in relation to a keyboard.

16. A system comprising:
a computer keyboard having a right foot and a left foot;
an organizer having
a body having a right end, a left end spaced from the right end in a lengthwise direction, a forward margin extending lengthwise from the right end to the left end of the body, and a central rear margin spaced rearwardly from the forward margin and extending in a lengthwise direction, the central rear margin having a left end rightwardly spaced from the left end of the body and a right end which is leftwardly spaced from the right end of the body;
at least one compartment disposed between the right end, left end, forward margin, and central rear margin of the body;
a left keyboard attachment section disposed between the left end of the body and the left end of the central rear margin, the left keyboard attachment section extending rearwardly from the central rear margin of the body; and
a right keyboard attachment section disposed between the right end of the body and the right end of the central rear margin, the right keyboard attachment section extending rearwardly from the central rear margin of the body and being spaced from the left keyboard attachment section by the central rear margin;
wherein each keyboard attachment section includes at least one of a first lengthwise elongate slot or a recess adapted to receive a foot of the keyboard.

17. The system of claim 16, further comprising a bottom surface and a bottom plane, wherein multiple spaced-apart points of the bottom surface are coplanar with the bottom plane.

18. The system of claim 17, further comprising a support surface on each foot;
wherein the left and right keyboard attachment sections each have a first elongate slot, the support surface of each foot disposed to be inserted through the respective first elongate slot and disposed to be coplanar with the bottom plane.

19. The system of claim 17, wherein the left and right keyboard attachment sections each comprise a recess having a recess bottom, the depth and position of each recess bottom being preselected such that only a thickness of the recess bottom spaces the support surface of each foot from the bottom plane.

20. The system of claim 17, further comprising a top contact plane of the organizer;
wherein an angle of the keyboard as produced by extending the feet substantially matches the angle between the top plane and the bottom plane.

21. The system of claim 20, wherein the angle between the top plane and the bottom plane is in a range from about five degrees to about thirty degrees.

22. The system of claim 18, each keyboard attachment section further comprising a second lengthwise elongate slot disposed to be forward of the first elongate slot, making the position of the organizer adjustable in relation to the keyboard.

23. The system of claim 19, further comprising a plurality of lengthwise elongate recesses, each recess being separated from the others by an upstanding wall and being adapted to receive a foot of the keyboard.

24. A system comprising:
a wireless computer keyboard having a right foot and a left foot;
an organizer having
a body having a right end, a left end spaced from the right end in a lengthwise direction, a forward margin extending lengthwise from the right end to the left end, and a rear margin spaced rearwardly from the forward margin and extending in a lengthwise direction;
at least one compartment between the right end, left end, forward margin, and rear margin; and
a composite keyboard attachment section disposed from the left end of the body to the right end of the body and extending rearwardly from the rear margin of the body.
